(19) United States
(12) Patent Application Publication
(10) Pub. No.: US 2005/0051249 A1
(43) Pub. Date: Mar. 10, 2005

(54) Run-flat tire

(76) Inventor: Gul Nam Lee, Norwalk, CA (US)

Correspondence Address: JONATHAN Y. KANG, ESQ.;LEE, HONG, DEGERMAN, KANG & SCHMADEKA P.C., 14th Floor, 801 S. Figueroa Street, Los Angeles, CA, 90017, US

(21) Appl. No.: 10/655,797

(22) Filed: Sep. 5, 2003

(51) Int. Cl. B60C 23/00; B60C 17/00; B60C 19/00; B60C 5/20; B60C 17/01

(52) U.S. Cl. 152/158; 152/157; 152/317; 152/336.1; 152/152.1; 152/518

(57) ABSTRACT

Disclosed is a run-flat tire and condition sensing assembly for vehicle tires. The assembly comprises plurality of rounded, support objects, wherein each object comprises an interior, an interior surface, and an outer shell. There is also at least one rounded, sensor object comprising an interior, an interior surface, and an outer shell. A pressure sensor, which detects pressure and transmits a corresponding signal, is situated within the sensor object. A net houses the plurality of rounded, support and sensor objects. The interiors of the support objects can be filled with pressurized helium gas, an elastic material or contain a support structure. Accordingly, during deflation of the tire, the sensor alerts the driver of the deflation while the plurality of support objects prevents radical deformation of the tire and allows the driver to operate the vehicle to safety.

### BACKGROUND OF THE INVENTION

1. Field of the Invention

The present invention relates to a run-flat tire, and more particularly, to a run-flat tire and condition sensing assembly having a plurality of rounded objects.

2. Description of the Related Art

Suffering rapid or gradual deflation of one or more tires while driving a vehicle can result in potentially life-threatening situations. Several solutions have been sought to limit or reduce this potential while achieving cost efficiency in producing that solution as well as efficiency in operating the vehicle. Apart from improved construction of the tires themselves, the most popular solutions have been tire inserts and tire pressure sensors and monitors.

Currently, there are various types of tire inserts and tire assemblies that allow a driver to operate a vehicle with one or more deflated tires. Many of these inserts fit around the rim within the tire and are constructed of durable material in order to support the weight of the vehicle and undergo dynamic forces during rapid or gradual deflation. However, these inserts can be costly to manufacture and install due to their complex design and construction. Furthermore, such inserts require specialized wheel rims and tires or are generally specific to different wheel rim and tire types, resulting in decreased adaptability for wider use.

There are also various types of sensors and sensory systems employed to provide a driver of a vehicle with tire conditions. Generally, these sensor units, which are placed within the tires, are limited to providing air pressure conditions within the tire. A driver may be alerted by an auditory or visual signal while driving that indicates low air pressure in one or more of the tires. Although such a sensor may prevent further deflation by alerting the driver so that he may take steps to reduce further deflation, these sensors do not assist the driver once deflation has already occurred. In addition, if a severe blowout was to occur, the sensor would likely be damaged and its replacement may prove to be costly.

Consequently, a more efficient system is necessary to adequately address all of the aforementioned problems.

### SUMMARY OF THE INVENTION

Accordingly, the present invention is directed to a run-flat tire and condition sensing assembly that substantially obviates one or more problems due to limitations and disadvantages of the related art above.

An object of the present invention is to provide a run-flat tire and condition sensing assembly with a plurality of rounded objects to support the tire during deflation.

Another object of the present invention is to provide an indication of deflation the tire.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, there is provided a run-flat tire assembly for use in a vehicle tire, the assembly comprising a plurality of rounded objects within the tire, wherein each rounded object comprises an interior, an interior surface and an outer shell. Also, the plurality of rounded objects comprise one or more sensor objects having at least one condition sensor that senses a condition and transmits a signal corresponding to the condition. Preferably, the rounded objects are substantially spherical in shape.

According to one aspect of the present invention, the condition sensor is situated within the sensor object and is operatively connected to the interior surface and the outer shell of the sensor object. Furthermore, the sensor detects pressure that is directed onto the outer shell of the object having the condition sensor, wherein the pressure is exerted by contact with one or more of the rounded objects.

According to other aspects of the present invention, the plurality of rounded objects is arranged within a net inside of the tire and each object further comprises a support structure situated within the rounded object, the support structure comprising a plurality of support bars. Each support bar radiates from the center of the object's interior and is affixed to the interior surface of the object. The support structure may be comprised of a polymer, metal or rubber.

According to one aspect of an alternative embodiment of the present invention, the interior of each rounded object comprises pressurized gas, preferably helium. The interior can also comprise elastic material such as foam, rubber or plastic.

It is to be understood that both the foregoing general description and the following detailed description are exemplary and explanatory and are intended to further describe the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1A illustrates a partial cross-sectional view of a rounded, support object according to the present invention;

FIG. 1B illustrates a perspective view of an incised rounded, support object according to an alternative embodiment of the present invention;

FIG. 2 illustrates a perspective view of a sensor within a rounded object according to the present invention;

FIG. 3 illustrates a diagram of the dynamic interactions between rounded, support objects and a rounded, sensor object according to the present invention;

FIG. 4 illustrates a cross-sectional view of a vehicle tire having a run-flat tire and condition sensing assembly according to the present invention; and

FIG. 5 illustrates a cross-sectional view of a deflated vehicle tire having a run-flat tire and condition sensing assembly according to the present invention.

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

Reference will now be made in detail to one or more embodiments of the invention, examples of which are illustrated in the accompanying drawings.

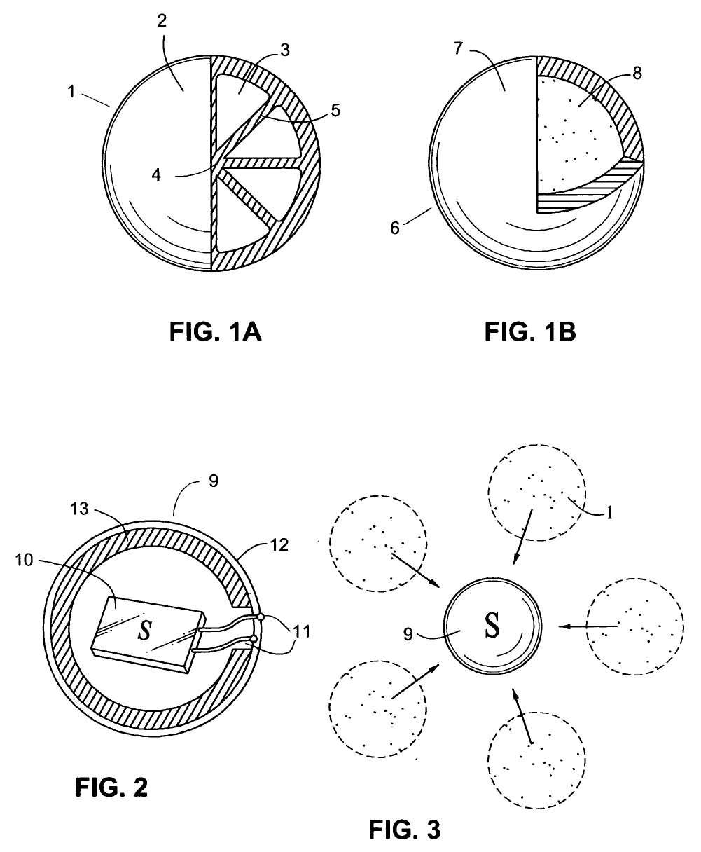

In FIG. 1A, a rounded, support object 1 in accordance with the present invention is illustrated. A plurality of rounded, support objects is to be arranged within the interior of a tire to provide support when the tire is deflated. The rounded, support object comprises an outer shell 2 and an interior 3. Within the interior 3, a support structure 4 is situated. The support structure comprises a plurality of support arms 5 that span diametrally to prevent extreme and permanent deformation and compression of the support object. Such deformation would otherwise occur as a result of increased contact between support objects during deflation of the tire. The support structure is comprised of a polymer, metal or rubber.

An alternative embodiment of the rounded, support object is illustrated in FIG. 1B. The support object 6 of the alternative embodiment also has an outer shell 7 and an interior 8. However, in this embodiment, a gas is introduced into the interior 8. Preferably, the gas is pressurized so as to provide the rounded, support object with elasticity and prevent the deformation described above that would otherwise occur as a result of increased contact between the support objects. Additionally, the pressurized gas is preferably helium, which results in the support object having lighter weight. However, other non-volatile gases well known in the art can be used to inflate the support objects. Alternatively, the interior 8 may comprise rubber, foam, or a polymer to enhance structural rigidity of the support object 6.

Preferably, the support object 1 or 6 is spherical in shape and constructed of a lightweight, elastic material comprising a metal, a polymer, or rubber. Furthermore, the rounded, support objects are constructed of sufficient rigidity to be able to collectively support the distributed weight of a vehicle. The support objects of the present invention have a maximal diameter ranging from 20 mm to 150 mm. Generally, support objects with larger diameters correspond to larger vehicle tires. Furthermore, larger vehicle tires, such as for military vehicles, are preferably equipped with the alternative embodiment described above and shown in FIG. 1B in order to reduce the overall weight of the tire. The plurality of rounded, support and sensor objects, described in detail below, comprise 75% to 95% of the interior space within a tire.

FIG. 2 illustrates a preferred embodiment of a sensor 10 within a rounded, sensor object 9. The sensor 10, which is of a type well known in the art, can sense one or more conditions and wirelessly transmit a signal corresponding to the condition sensed. In preferred embodiments of the present invention, at least one sensor object would be situated among the plurality of support objects. In FIG. 2, the sensor 10 is shown to have wire contacts 11 with the interior and exterior surfaces of the outer shell 12 of the object 9. A lining 13 covers the interior surface of the sensor object 9 except at the locations where the wire contacts 11 are connected to the outer shell 12. The lining 13 serves to protect and stabilize the sensor within the sensor object 9 and may comprise a polymer, rubber or other elastic material known to one of ordinary skill in the art.

Accordingly, the sensor detects pressure exerted on the sensor object 9 by contact with one or more support objects 1, as shown in FIG. 3. During deflation of a tire equipped with the present invention, compression of the plurality of objects 1 results in increased contact among the rounded, support and sensor objects. The sensor, having detected the increased pressure, transmits a signal wirelessly to a transponder or the like to alert the driver of deflation.

Alternatively, the sensor 10 can be similar to sensors described in related art regarding tire-monitoring systems. The sensor 10 can detect variations or loss of air pressure within the tire and transmit a signal to a computer, such as vehicle management system, to alert the driver of the change in air pressure. Alternatively, the sensor 10 can detect variations in air temperature within the tire that could result when the vehicle is traveling over extremely hot surfaces or when there is sufficient deflation so that the tire rim is in contact with the tire tread. The sensor 10 can wirelessly transmit a signal to alert the driver of deflation of the tire.

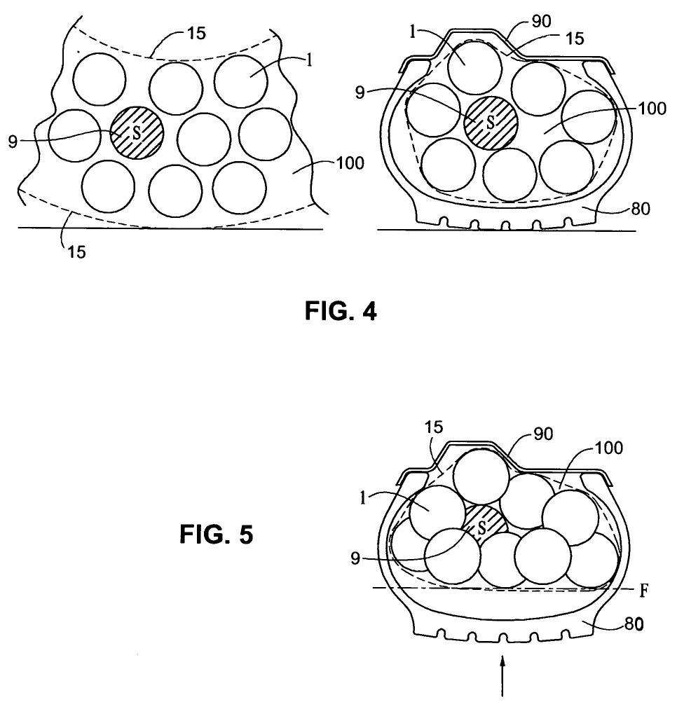

FIG. 4 illustrates a cross-sectional view of a vehicle tire having a run-flat tire and condition sensing assembly according to the present invention. The plurality of rounded, support objects 1 and rounded, sensor object 9 are situated within an interior space 100 of the wheel that is created by the wheel rim 90 and tire 80. The rounded objects 1 and 9 are collectively held within a semi-rigid net 15. Preferably, the net 15 is comprised of a metal such as steel or of carbon fiber so that, should tire or tread separation occur, the rounded, support and sensor objects would be contained and remain in operational contact with the wheel rim 90 while engaging a road surface. Also, the net 15 is preferably affixed to the wheel rim 90 to prevent the assembly from separating from the wheel rim 90 during or after tire separation.

FIG. 5 illustrates a cross-sectional view of a deflated vehicle tire having a run-flat tire and condition sensing assembly according to the present invention. When deflation occurs, the sidewalls of the tire 80 generally deform and bow outwards under the weight of the vehicle. As a result, the interior space 100 of the wheel expands horizontally but contracts vertically. However, the net 15 prevents the plurality of support objects 1 and the sensor objects 9 from conforming to the horizontal expansion of the interior space 100. This allows the wheel to retain a proper shape and prevents damage to the wheel rim 90. It also provides adequate support for the wheel so that a driver may continue to operate the vehicle and drive to a safe location for repair.

As vertical contraction occurs in a deflated wheel, the tread of the tire 80 is shifted to a level denoted by the dashed line “F” and indicated by the upward directed arrow. Consequently, the plurality of rounded, support objects 1 and rounded, sensor objects 9 are collectively compressed, resulting in increased contact among the objects. The sensor 10 of the sensor object 9 detects the increase in pressure resulting from the increase in contact. Having detected a specific amount of pressure that corresponds to a specific amount of deflation, the sensor 9 transmits a signal to the driver of the vehicle of deflation within that tire.

The run-flat tire and condition sensing assembly of the present invention provides vehicle operators with a more efficient and safe alternative for run-flat tires. The support objects are relatively inexpensive to manufacture. With the decreasing cost of wireless transmitters and sensors, production of the sensor objects is relatively inexpensive as well. The present invention is also highly adaptable to various combinations of wheel rims and tires. Furthermore, the present invention allows for relatively easy installation and would not require major alterations to the either the vehicle rim or the tire. Most importantly, the present invention decreases the safety risks associated with deflated tires and allows a driver to safely drive with deflated tires to proper tire repair and changing locations.

It will be apparent to those skilled in the art that various modifications and variations can be made in the present invention without departing from the spirit or scope of the invention. Therefore, the foregoing description of these embodiments of the present invention has been presented for the purposes of illustration and description. It is not intended to be exhaustive or to limit the invention to the precise form disclosed. Thus, it is intended that the present invention cover the modifications and variations of this invention provided they come within the scope of the appended claims and their equivalents. Preferred embodiments were shown in the context of standard, pneumatic vehicle tires. In alternative embodiments, foam filled tires can be substituted for the present invention.

1. A run-flat tire assembly for use in a vehicle tire, the assembly comprising a plurality of rounded objects within the tire.

2. The assembly of claim 1, wherein each rounded object comprises an interior, an interior surface and an outer shell.

3. The assembly of claim 2, wherein each rounded object further comprises a support structure situated within the rounded object, the support structure comprising a plurality of support bars that radiates from the center of the rounded object and is affixed to the interior surface of the rounded object.

4. The assembly of claim 2, wherein each rounded object further comprises pressurized gas within the interior of the rounded object.

5. The assembly of claim 4, wherein the gas comprises helium.

6. The assembly of claim 1, wherein each rounded object is substantially spherical in shape.

7. The assembly of claim 1, wherein the plurality of rounded objects comprise one or more rounded, sensor objects having at least one condition sensor that senses a condition and transmits a signal corresponding to the condition.

8. The assembly of claim 7, wherein the condition is air pressure within the tire.

9. The assembly of claim 7, wherein the condition is air temperature within the tire.

10. The assembly of claim 7, wherein the condition sensor is situated within the rounded, sensor object and is operatively connected to an outer shell of the sensor object.

11. The assembly of claim 10, wherein the condition is pressure directed onto the outer shell of the sensor object, the pressure being exerted by one or more rounded objects.

12. The assembly of claim 1, wherein the plurality of rounded objects is arranged within a net inside of the tire.

13. The assembly of claim 12, wherein the net comprises carbon fiber.

14. The assembly of claim 12, wherein the net comprises a metal.

15. The assembly of claim 12, wherein the net is affixed to a rim supporting the tire.

16. The assembly of claim 1, wherein each rounded object comprises a metal.

17. The assembly of claim 1, wherein each rounded object comprises rubber.

18. The assembly of claim 1, wherein each rounded object comprises a polymer.

19. The assembly of claim 1, wherein each rounded object has a maximal diameter ranging from 20 mm to 150 mm.

20. A run flat tire system for a vehicle, the system comprising:
a plurality of support spheres, wherein each sphere comprises an interior, an interior surface, and an outer shell;
at least one sensor sphere comprising an interior, an interior surface, and an outer shell;
a pressure sensor to detect pressure and transmit a signal that corresponds to the detection of pressure to a driver of the vehicle, the pressure sensor being situated within the sensor sphere and in operational contact with the interior surface and outer shell of the sensor; and
a net housing the plurality of support spheres and the at least one sensor sphere.

21. The system of claim 20, wherein each of the support spheres further comprises a support structure arranged within the sphere, the support structure comprising a plurality of diametral support arms affixed to the interior surface of the sphere.

22. The system of claim 20, wherein each of the support spheres further comprises pressurized helium housed in the interior of the sphere.
